(19) United States
(12) Patent Application Publication
(10) Pub. No.: US 2014/0242402 A1
(43) Pub. Date: Aug. 28, 2014

(54) FLEXIBLE COMPOSITE MATERIAL

(71) Applicant: EZYTUBE PTY LTD, Ingleburn, New South Wales (AU)

(72) Inventors: Kevin Adams, Ingleburn (AU); Mariano Villaescusa, Ingleburn (AU)

(21) Appl. No.: 14/348,454

(22) PCT Filed: Sep. 28, 2012
(86) PCT No.: PCT/AU2012/001189

§ 371 Date: Mar. 28, 2014

(30) Foreign Application Priority Data
Sep. 30, 2011 (AU) 2011904019

(51) Int. Cl. B32B 27/10; B32B 29/00; B32B 27/32; B32B 27/36

(52) U.S. Cl. CPC B32B 27/10; B32B 27/36; B32B 29/002; B32B 27/32
USPC 428/481; 428/513

(57) ABSTRACT

A concrete formwork liner comprising a flexible laminate material, said material including at least one sub-layer of paper bonded to a layer of plastic, wherein the plastic layer makes direct contact with the concrete.

### TECHNICAL FIELD

The invention relates to the field of manufacture of flexible composite materials. In particular, the invention relates to a lining suitable for use during concrete forming, constructed from an improved flexible laminate material.

### BACKGROUND OF THE INVENTION

Flexible sheeting is an increasingly important tool in the construction industry. Particularly so where there is a requirement for sheets or linings that are strong, flexible, water-proof or water-resistant, and with surface properties that are advantageous in relation to their roles on the building site.

For example, as architects design buildings and other structures that require increasingly more complex and expansive concrete castings, in particular concrete surfaces that remain exposed, there is a growing desire for a more sophisticated, higher class of surface finish achieved when using concrete formwork.

Traditional methods used for forming concrete slabs, beams, walls and other concrete structures commonly involve the installation of multiple sheets of plywood, timber faced metal framed panels or large timber table forms. These forms are held in place by shoring, props, scaffolding or similar restraining means.

Some of these formwork components may comprise a finish or layer which is intended to improve the reuse potential of the form, or improve the surface finish of the individual component.

Traditional formwork systems are commonly used without any kind of liner, which tends to cause a number of problems, including that the panels can only be re-used a limited number of times, due to the caustic nature of the concrete, which makes the material cost relatively high; the concrete surface will usually have defects such as discoloration due to the properties of the wood; the wood panels do not have very good release properties, making disassembly difficult.

It has been proposed to augment the traditional wooden formwork with a liner that will alleviate some of these problems. However, the liners that have been tried have not proven to be completely satisfactory.

Known concrete formwork liner prior art includes laminated sheeting which is primarily designed provide a drainage structure which allows the surplus water and air contained within the concrete to permeate through the liner and drain away from the surface of the concrete. U.S. Pat. No. 5,302,099 discloses such a laminate based upon a porous fabric which is laminated to a drainage scrim.

U.S. Pat. No. 2,432,002 discloses a different version of a form liner with drainage characteristics by using sized fibre insulation board, having fibres which are relatively large and course compared with paper fibre. This structure has a large concentration of fine pores that allow water and air to pass through.

EP 0662028B1 by E.I Du Pont De Nemours & Company discloses a plastic based drainage cell form liner which effectively increases the structural integrity of the concrete surface which is created. This is important for structures such as dam walls, bridges and other structures requiring long term exposure to aggressive environments or weather and water, however many concrete structures are not exposed to such elements, and non-porous form liners are more appropriate.

Poly-propylene (PP) sheeting is one of a number of polymer sheeting materials that have been used for this purpose. These plastics are normally in a sheet form, maybe vacuum formed to create different surface features such as wood grain, brick or sandstone replications. Unfortunately, these and other polymer materials tend to suffer from poor dimensional stability in adverse weather conditions often encountered in outdoor applications such a building sites. For example, PP sheeting dimensions can vary by up to 1% in normal weather conditions, which is not acceptable. It can also tend to ‘bubble’ or crease in these conditions, which adversely affects the surface finish of the concrete.

To overcome these expansion and contraction issues, these materials are usually manufactured in smaller dimensions such as sheets to allow for movements in the liner. This often results in a significant amount of joints around the edges of each sheet which are often not suited to providing a smooth off form finish.

In addition, release of the sheeting from the concrete can be difficult for many polymer materials, sometimes requiring the addition of a surface release agent prior to concrete pouring. This is not desirable, as the coated surface may become slippery and dangerous to foot traffic, and as wet weather can wash the release agent away, which is particularly undesirable as such chemicals are usually very damaging to the environment.

Accordingly, it is an object of the invention to provide a flexible sheeting that is useful in construction, particularly as a concrete form liner, that is less affected by the problems associated with the prior art as discussed above.

An alternative object of the invention is to provide an intermediate layer/liner which will improve the appearance of the cast concrete structure. This may include, minimising the visual effects of joins at each component, and/or preventing leakage of water and fine components of the concrete which would otherwise result in a rough, textured or stepped surface finish on the formed concrete.

### SUMMARY OF THE INVENTION

According to one aspect of the invention, there is provided a concrete formwork liner constructed substantially from a flexible laminate material said material including at least one sub-layer of plastic coated paper.

Preferably, the invention provides a concrete formwork liner, comprising a flexible laminate material, said material including at least one sub-layer of relatively moisture-resistant paper (such as kraft paper) bonded to a plastic film by a molten layer of plastic extrusion, wherein the plastic film layer is adapted to make direct contact with the concrete.

Preferably, the plastic material adapted to contact the concrete is selected from the group comprising polyethylene (PE), polyethylene terephthalate (PET), high density polyethylene (HDPE), low density polyethylene (LDPE) and biaxially oriented polypropylene (BOPP).

This type of liner material is a very useful basis for a number of applications. It may be used by itself, or combined with other material layers. It is relatively impervious to moisture migration, as well as having excellent dimensional stability in outdoor conditions.

The material's relative flexibility, given that it is also well-adapted to outdoor use, makes it ideal for use as a liner for concrete formwork, where it produces a very smooth surface finish and can be used to form curved surfaces very effectively. This in turn allows the timber or other material that makes up the solid support for the concrete formwork to be re-used more often, as the liner protects the timber from moisture and other damage.

The material has clear advantages over the prior art, where moisture migration can cause problems. For example, discoloration of the surface of cast concrete can readily occur where even very small amounts of water can wick through microscopic openings in the formwork, allowing water to seep away from the surface of the concrete as it sets, causing a coarse and porous surface finish.

Also as the laminate is a composite of paper and plastic, the paper elements offer the advantages of relatively high dimensional stability which minimises expansion and contraction as a result of thermal changes, as well as water resistance and excellent release properties from the concrete due to the properties of the plastic outer film and inner extrusion layers.

The plastic coating or film surface layer also imparts excellent release properties to the liner, compared with other materials, obviating the need for a separately applied release agent, which can be time-consuming to apply, and may wash off, leading to adverse practical and environmental impacts.

In addition, because the inventive laminated material can be manufactured in a bulk roll form, it is easily rolled out over large surface areas with minimal seams/joins, e.g. a concrete formwork liner can produce a relatively seamless surface finish.

Preferably, the paper is bonded to the plastic film layer via an intermediate layer of polyethylene (PE), polypropylene (PP), high density polyethylene (HDPE) or other suitable plastic films or adhesives.

A particularly advantageous embodiment is one where the laminate is formed from the bonding together of two above described sub-layers bonded to one another, preferably wherein the sub-layers are bonded via the respective paper surfaces in a ‘back-to-back’ manner.

This embodiment has been found to be extremely resistant to the ingress of moisture into the paper layers at the edges of the roll, making the laminated structure very suitable for use in wet and outdoor environments.

Now will be described, by way of a particular, non-limiting example, a preferred embodiment of the invention.

### DETAILED DESCRIPTION OF THE INVENTION

The invention can readily be put into practice in the form of a roll of relatively moisture-resistant paper, such as kraft paper, bonded to an ‘outer’ layer of plastic film. The bonding of these two layers together can be achieved using a polymer resin intermediate layer, such as PE or HDPE. Preferably, the laminate is formed by taking separate rolls of the water resistant paper and plastic film and extruding the PE/HDPE layers between the film and paper layers between a set of rollers to effect a fully bonded laminate as a continuous lamination operation.

There are a number of suitable plastic film types available and well known in the art. These include polyethylene (PE), polyethylene terephthalate (PET), high density polyethylene (HDPE), low density polyethylene (LDPE) and biaxially oriented polypropylene (BOPP).

This manufacturing process and choice of materials readily allows sheets of at least 2.4 m width to be produced, and it may be possible to produce sheets of up to 3.0 m in width.

A preferred embodiment can be produced where two such laminated structures are bonded to one another ‘back-to-back’ via the kraft paper layers, using a further bonding layer of PE or HDPE. This embodiment has a very strong ability to resist moisture ingress, both through the sheet itself, and into the kraft paper layers via the edges of the sheet. This also enables a lower grade of kraft paper to be used.

This makes it particularly useful as a concrete form liner.

### EXAMPLE—CONCRETE FORM LINER

A concrete form liner is manufactured by:
1. co-extruding a 12 μm layer of PET on to 270 HP kraft paper, using an intermediate bonding layer of HDPE to create a sub layer; then
2. laminating two rolls of the sub-layer together, with the kraft paper layers as bonding surfaces, using HDPE resin again as the bonding agent.

The resultant sheet then has outward facing polyethylene layers and a grammage of about 638 gsm. It can be coloured, such as by mixing a dye with the HDPE bonding layer to give a colourful appearance.

A concrete form of wood panels would be constructed, said panels defining the location of the surface of the concrete pouring.

The liner can then be laid evenly across the wooden form. The wooden formwork may include other features, such as one or more ‘trenches’ in the formwork which will define ‘ribs’ on the final concrete slab.

Steel reinforcing bars may then be positioned on top of the form-liner on suitable bar chairs for the concrete pour, and the concrete is poured into the formwork with the liner in place.

The concrete then sets over a period of time, and the form work is removed. The liner releases smoothly and evenly away from the concrete surface, leaving a surface that is smooth and free from discolorations, surface undulations or other faults.

Kraft paper was used in the above example, but other suitable papers may be used, such as highly sized papers, Semichem papers, high performance kraft papers, and others.

The most preferred way of applying the plastic layer is via the application of a film, however a plastic extrusion applied to the outer side of the paper may also be effective.

The most preferred film currently is PET, however other films are available and may also be suitable (or advantageous), particularly where a matt finish is desired.

It is advantageous to be able to offer a plastic coating of either gloss or matt finish, in that high gloss finishes look attractive when conditions are ideal, however they can show all defects when the concrete pour is not perfect. This is not as critical if the concrete is to be painted—however a matt finish is also preferred where there is a need to overcome a perception of difficulty of the paint sticking to a glossy concrete surface).

As an alternative, by having two laminates according to the invention bonded ‘back to back’, it is possible to offer two different finishes (matt on one side & gloss on the other side) to offer alternative finishes.

Extruded plastic also acts to increase the plastic content at the surface to offer improved impact resistance to the concrete and aggregate whist the concrete is being poured.

An alternative structure is to use additional thinner layers of paper with additional plastic extrusion therebetween (for example, four thinner layers of paper rather than the two thicker layers as disclosed in the example above.

It will be appreciated by persons skilled in the art that the above described embodiments are not the only ways in which the invention can be put into practice. There are other alternative embodiments which, while different in some details, nevertheless fall within the scope of the invention.

For example, while polyethylene is a known material which is suitable concrete-contact layer for many applications of the invention, other contact layer plastics may be contemplated. Equally, other paper types may be selected for use in suitable situations.

Also, other more complex layered structures of polymer and paper may be used to create a liner in accordance with the invention, which nevertheless is based on the invention.

1. A concrete formwork liner, comprising a flexible laminate material, said material including at least one sub-layer of relatively moisture-resistant paper bonded to a layer of plastic film, wherein the plastic film layer is adapted to make direct contact with the concrete.

2. The laminate material of claim 1 , wherein the plastic film is selected from the group comprising polyethylene (PE), polyethylene terephthalate (PET), high density polyethylene (HDPE), low density polyethylene (LDPE) and biaxially oriented polypropylene (BOPP).

3. The laminate material of claim 2, wherein the plastic film is extruded.

4. The laminate material according to claim 1, wherein there are two sub-layers bonded to one another.

5. The laminate material of claim 4, wherein the sub-layers are bonded via the respective paper surfaces.

6. The laminate material of claim 5, wherein the respective paper surfaces are bonded via PE, polypropylene (PP) or HDPE.

7. The concrete formwork liner according to claim 1, wherein there are one or more sub-layers bonded to one another.

8. A concrete formwork liner substantially as herein described with respect to the examples.

9. A flexible laminate material, suitable for use as a concrete formwork liner, substantially as herein described with respect to the examples.
